(19) United States
(12) Patent Application Publication
(10) Pub. No.: US 2026/0240633 A1
(43) Pub. Date: Aug. 20, 2026

(54) HEAT FORMABLE DENTURE HAVING ADJUSTABLE TEETH

(71) Applicant: SONRISA, LLC, Wilmington, NC (US)

(72) Inventor: Misael Otero, Wilmington, NC (US)

(21) Appl. No.: 19/093,164

(22) Filed: Mar. 27, 2025

Related U.S. Application Data
(60) Provisional application No. 63/760,342, filed on Feb. 19, 2025.

(51) Int. Cl. A61C 13/00; A61C 13/08; A61C 13/087

(52) U.S. Cl. CPC A61C 13/0024; A61C 13/081; A61C 13/087

(57) ABSTRACT

The present disclosure relates to a multi-layer, heat moldable dental prosthetic articles, including full and partial dentures. More specifically, the present invention concerns a dental prosthetic device comprising a remoldable material, such as a high-impact thermoplastic material, which conforms to at least a portion of a dental arch, and at least one heat moldable tooth-like structure contiguous with or otherwise associated with a heat moldable gum layer.

### CROSS-REFERENCE TO RELATED APPLICATIONS

This application claims the benefit of previously filed U.S. Provisional Patent Application No. 63/760,342 filed: 19 Aug. 2024, titled: Dental Apparatus, Material, and Method of Manufacture, which is incorporated herein by reference in its entirety.

### FIELD OF THE DISCLOSURE

The present disclosure relates to a multi-layer dental prosthetic device, e.g., denture, formed of high-impact thermoplastic or heat moldable materials, which when heated, for example, in boiling water, is fully flexible. The “boil-and-bite” denture as described herein may include full or partial dentures. As described herein, each layer of the denture is flexible, including the teeth, which allows them to be fully customizable and fitted by warming.

### BACKGROUND

Dentures are removable plates or frames that hold artificial teeth. Denture manufacturing is conventionally driven by a dentist for an individual patient. The dentist works in concert with a laboratory to have individually manufactured teeth pressed into wax, which is melted out and replaced with resin. Patients are typically fitted multiple times with the denture. Each fitting can involve sending the denture back to the laboratory for additional adjustment.

While effective at restoring a patient's ability to chew and smile confidently, the denture manufacturing process can be expensive and time consuming. For those with limited financial means or access to oral care professionals, the expense and complex process can frustrate the potential benefits of dentures.

Therefore, there exists a need in the art for a convenient, fully customizable, easy to use, and inexpensive denture system that allows patients fit without the need for professional assistance but that provides the feel and function of a traditional denture.

### SUMMARY

Presently described are universal fit, multi-layer, heat moldable (i.e., boil-and-bite) denture articles comprising a plurality of high-impact, heat-moldable layers, and including a high-impact, heat moldable tooth layer and a high-impact heat moldable gingival layer, wherein the entire denture can change shape with heat (i.e., is reversibly deformable). In other words, all portions or layers of the denture may be heat formable and modifiable. In particular, the disclosure provides a multi-layer denture article, which fully flexible when heated, for example, in boiling water. The “boil-and-bite” denture as described herein may include full or partial dentures. The disclosure also provides methods of making and using the same.

Thus, in an aspect, the disclosure provides a multi-layer, heat moldable denture comprising a first portion or layer comprising a high-impact thermoplastic or heat moldable material, wherein the first portion or layer includes at least one heat moldable tooth; and a gingival portion or layer comprising a high-impact thermoplastic or heat moldable material positioned proximal to or connected to the first portion or layer, wherein (when heated) the gingival portion is ductile and malleable to be fitted to contours of gingival tissue surface of a subject.

In any aspect or embodiment described herein, the gingival portion or layer is permanently affixed to the first portion or layer. In any aspect or embodiment described herein, the first portion or layer and the gingival portion or layer comprises the different heat moldable high-impact thermoplastic materials. In any aspect or embodiment described herein, the gingival portion or layer comprises a non-acrylic based high-impact thermoplastic or heat moldable material. In any aspect or embodiment described herein, the high-impact thermoplastic or heat moldable material of the first portion or layer has a higher elastic modulus (i.e., higher stiffness) at about 60° C. than the gingival high-impact thermoplastic or heat moldable material.

In any aspect or embodiment described herein, the first portion or layer comprises a plurality of heat moldable teeth. In any aspect or embodiment described herein, the plurality of heat moldable teeth are individually or collectively adjustable; and/or deformable; and/or pliable or reformable. In any aspect or embodiment described herein, the plurality of heat moldable teeth are each formed of a high-impact thermoplastic or heat moldable material.

In any aspect or embodiment described herein, the first portion or layer comprises a first high-impact thermoplastic or heat moldable material. In any aspect or embodiment described herein, the gingival portion or layer comprises a second high-impact thermoplastic or heat moldable material.

In any aspect or embodiment described herein, the multi-layer, heat moldable denture is an upper (i.e., maxilla) denture, and includes a heat moldable palate portion that, when heated, is ductile and malleable to be fitted to contours of the palate surface of the subject. In any aspect or embodiment described herein, the palate portion is expandable or configured with features to provide at least one of improved positioning, fixation, stability or combination thereof to improve the occlusion of the teeth. In any aspect or embodiment described herein, the palate portion comprises at least one of a post, cut, channel, dimple or combination thereof that allows the palate portion to expand, stretch, and/or adhere to a subject's palate anatomy to improve the occlusion of the teeth.

In any aspect or embodiment described herein, the denture further comprises a separate, heat moldable palate insert to improve denture positioning and/or comfort.

In any aspect or embodiment described herein, the multi-layer, heat moldable denture is a lower (i.e., mandible) denture.

In any aspect or embodiment described herein, the high-impact thermoplastic or heat moldable material comprises at least one high impact acrylic heat moldable material. In any aspect or embodiment described herein, the at least one high impact acrylic heat moldable material comprises polymethyl methacrylate (PMMA) and methyl methacrylate (MMA) monomer and optionally, a plasticizer, an emulsifier or a combination thereof. In any aspect or embodiment, the gingival portion or layer comprises at least one of (poly)ethylene (e.g., polyethylene vinyl acetate), polycarbonate, polycaprolactone, or a combination thereof.

In any aspect or embodiment described herein, the multi-layer, heat moldable denture comprises an intermediate portion or layer proximate to or connected to the first portion or layer and the gingival portion or layer, wherein the intermediate portion or layer comprises a heat moldable material. In any aspect or embodiment described herein, the heat moldable material of the intermediate portion or layer is the same as the material of the first portion or layer In an additional aspect, the disclosure provides a method of manufacturing a multi-layer, heat moldable denture comprising the steps of molding a first layer comprising a high-impact thermoplastic or heat moldable material, wherein the first layer includes at least one heat moldable tooth; and overmolding a gingival layer onto the first layer, wherein the gingival layer comprises a high-impact thermoplastic or heat moldable material, and wherein the gingival layer is ductile and malleable to be fitted to contours of gingival and/or palate surface of a subject.

In any aspect or embodiment described herein, the denture is injection molded or 3D printed.

In any aspect or embodiment described herein, the method comprises the step of overmolding an intermediate layer comprising a high-impact thermoplastic or heat moldable material onto the first layer, and then overmolding the gingival layer comprising a high-impact thermoplastic or heat moldable material onto the intermediate layer. In any aspect or embodiment described herein, the heat moldable material of the intermediate layer is the same as the first portion or layer or different from the first portion or layer and the gingival portion or layer.

In any aspect or embodiment described herein, the first portion or layer comprises a plurality of heat moldable teeth. In any aspect or embodiment described herein, the plurality of heat moldable teeth are individually or collectively adjustable; and/or deformable; and/or pliable or reformable. In any aspect or embodiment described herein, the plurality of heat moldable teeth are each formed of a heat moldable high-impact thermoplastic or heat moldable material.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 shows a front view of an exemplary embodiment a of a first portion or layer 100 of the multi-layer, heat moldable denture described herein comprising a high-impact thermoplastic or heat moldable material as described herein, and including a plurality of heat moldable teeth 110. The figure illustrates a set of teeth for an upper (maxilla) denture.

FIG. 2 shows a side view of the tooth layer 100 of FIG. 1.

FIG. 3 shows a bottom view (occlusal view) of the first portion or layer (i.e., tooth layer) of FIG. 1, and illustrates bracket structures 120 that impart strength and stability to the teeth in the first layer when embedded into subsequent overmolded layers.

FIG. 4 shows a top view (apical view) of the first portion or layer (i.e., tooth layer) of FIG. 1, and illustrates bracket structures 120 that impart strength and stability to the teeth in the first layer when embedded into subsequent overmolded layers.

FIG. 5 shows a bottom view (occlusal view) of a multi-layer heat moldable denture 500 as described herein including a first portion or layer 100 including at least one tooth-like structure 110, and an additional high-impact thermoplastic or heat moldable layer 510 overmolded or affixed to the first portion or layer 100.

FIG. 6 shows a front view of the denture 500 of FIG. 5.

FIG. 7 shows a top view of the denture 500 of FIG. 5.

FIG. 8 shows a side view of the denture 500 of FIG. 5.

FIG. 9 shows a top perspective view of the denture 500 of FIG. 5.

FIG. 10 shows a bottom view (occlusal view) of a multi-layer heat moldable denture 1000 as described herein including a first portion or layer 100 including at least one tooth-like structure 110, an intermediate layer comprising a high-impact thermoplastic or heat moldable layer 510 overmolded or affixed to the first portion or layer 100, and including a gingival portion or layer 1010 comprising a high-impact thermoplastic or heat moldable material overmolded onto the intermediate layer 510. In the example, the gingival portion or layer 1010 includes a palate portion.

FIG. 11 shows a front view of the denture 1000 of FIG. 10.

FIG. 12 shows a top view of the denture 1000 of FIG. 10.

FIG. 13 shows a side view of the denture 1000 of FIG. 10.

FIG. 14 shows a bottom perspective view of the denture 1000 of FIG. 10.

FIG. 15 shows a top view (occlusal view) of a first portion or layer (i.e., tooth layer) 1500 of a lower denture including teeth 1510, and illustrates bracket structures 1520 that impart strength and stability to the teeth in the first layer when embedded into subsequent overmolded layers.

FIG. 16 shows a side view of the tooth layer 1500 of FIG. 15.

FIG. 17 shows a bottom view (occlusal view) of a first portion or layer (i.e., tooth layer) 1500 of FIG. 15.

FIG. 18 shows a posterior view of a first portion or layer (i.e., tooth layer) 1500 of a lower denture, and illustrates bracket structures 1520 that impart strength and stability to the teeth in the first layer when embedded into subsequent overmolded layers.

FIG. 19 shows a side view of a multi-layer heat moldable denture 1900 as described herein including a first portion or layer 1500 including at least one tooth-like structure 1500, and an additional high-impact thermoplastic or heat moldable layer 1910 overmolded or affixed to the first portion or layer 1500.

FIG. 20 shows a top view of the multi-layer heat moldable denture 1900 of FIG. 19.

FIG. 21 shows a bottom view of the multi-layer heat moldable denture 1900 of FIG. 19.

FIG. 22 shows a posterior view of the multi-layer heat moldable denture 1900 of FIG. 19.

FIG. 23 shows a posterior view of a multi-layer heat moldable denture 2300 as described herein including a first portion or layer 1500 including at least one tooth-like structure 1510, an intermediate layer comprising a high-impact thermoplastic or heat moldable layer 1910 overmolded or affixed to the first portion or layer 1500, and including a gingival portion or layer 2310 comprising a high-impact thermoplastic or heat moldable material overmolded onto the intermediate layer 1910.

FIG. 24 shows a bottom perspective view of the multi-layer heat moldable denture 2300 of FIG. 23.

FIG. 25 shows a side view of the multi-layer heat moldable denture 2300 of FIG. 23.

FIG. 26 shows a top view of the multi-layer heat moldable denture 2300 of FIG. 23.

### DETAILED DESCRIPTION

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited.

It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether or not the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety.

Unless otherwise defined, all technical and scientific terms used herein have the same meaning as commonly understood by one of ordinary skill in the art to which this invention belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

As used herein, unless the context clearly indicates otherwise, the terms “heat moldable,” “heat pliable”, “heat flexible”, and “thermoplastic” are used in their general sense and interchangeably in reference to high-impact thermoplastic resin or polymeric materials and denture articles formed of the same that become relatively soft and moldable when sufficiently heated but are rigid when cooled.

Occlusion for purposes of this disclosure refers to a physical relationship between teeth. For instance, occlusion may refer to a relationship between maxillary (upper) and mandibular (lower) teeth as they approach each other.

Presently described are multi-layer, boil-and-bite denture articles comprising a plurality of heat-flexible layers, and including a heat-flexible tooth layer, wherein the entire denture can change shape with heat (i.e., is reversibly deformable). In other words, all portions or layers of the denture, including the teeth, are heat moldable and adjustable. As described herein, the multi-layer denture article is fully flexible when heated, for example, in boiling water, and is rigid when cooled. The “boil-and-bite” denture as described herein may include full or partial dentures. The disclosure also provides methods of making and using the same.

Thus, in one aspect, the disclosure provides a multi-layer, heat moldable denture comprising, consisting essentially of or consisting of a first portion or layer comprising a high-impact thermoplastic or heat moldable material, and including at least one heat moldable tooth-like structure. That is to say, the tooth/teeth themselves are formed of a heat moldable material. As such, rather than using premanufactured denture teeth that are inlayed into a mold, the dentures as provided herein are entirely formed of a high-impact thermoplastic or heat moldable resin, including the teeth, and molded (e.g., injection or 3D printed) in separate portions or layers, e.g., 2 or 3 or more.

In an embodiment, the disclosure provides a multi-layer, heat moldable denture comprising a first portion or layer comprising, consisting essentially of or consisting of a heat-moldable material, wherein the first portion or layer includes at least one heat-moldable tooth-like structure (herein, “tooth” or “teeth”); and a gingival portion or layer comprising, consisting essentially of or consisting of a heat-moldable material positioned proximate to or affixed to the first portion or layer. When heated, the denture is ductile and malleable to be fitted to contours of gingival tissue, and/or palate surface of a subject. Significantly, as contemplated, the at least one tooth in the first portion or layer is formed entirely of the heat moldable material rather than being, for example, individual rigid structures placed or anchored in the moldable layer. Accordingly, the tooth structure(s) in the denture as described herein retains its strength throughout and maintains its position during the heat molding and hardening process.

In any aspect or embodiment described herein, the first layer comprises a plurality of adjustable teeth. In any aspect or embodiment described herein, the plurality of adjustable teeth are individually or collectively adjustable; and/or deformable; and/or pliable or reformable. In any aspect or embodiment described herein, the plurality of adjustable teeth are each formed of a heat moldable high-impact thermoplastic polymer material. In still additional embodiments, the tooth-like structures are formed or configured to comprise a structure to impart stability and strength when an overmolded layer is included. In certain embodiments, the structure is a ledge, bracket or flange portion that extends inwardly, e.g., approximately perpendicularly with respect to the plane of the tooth, and extends from at or near the apical portion (i.e., the portion that contacts the gum-like gingival or intermediate portion or layer) of the tooth-like structure. In a preferred embodiment, the apical bracket or flange portion is relatively thin, e.g., 2 mm or less, so as to not affect or impact or contact the gums of the user or disrupt or distort the overmolded layer.

In any aspect or embodiment described herein, the first layer comprises a first heat moldable high-impact thermoplastic material.

In any aspect or embodiment described herein, the denture is a lower (i.e., mandible) denture or the denture is an upper (i.e., maxilla) denture, or both.

In any aspect or embodiment described herein, the gingival portion or layer is permanently affixed to the first portion or layer. In certain embodiments, the gingival portion or layer is overmolded onto the first portion or layer. In certain embodiments, when heated, the gingival portion or layer becomes soft, stretchable, and gum-like such that it gives an intimate fit against the gum tissue and, preferably is configured to provide a suction-cup grip against the tissues, which is ideal after the denture cools and hardens.

In any aspect or embodiment, the denture described herein includes at least one additional portion or layer bound or affixed to the first portion or layer, the gingival portion or layer or both, wherein the at least one additional portion or layer is formed of a high-impact, thermoplastic or heat-moldable material.

In certain embodiments, the first portion or layer, gingival portion or layer, and (if present) the at least one additional portion or layer of the multi-layer, heat moldable denture described herein are all configured to be softened at a temperature of from 40° C. to about 100° C., at a temperature of from about 50° C. to about 82° C., at a temperature of from about 60° C. to about 115° C., including all values and subranges in between. In certain embodiments, the first portion or layer, gingival portion or layer, and (if present) the at least one additional portion or layer are all configured to be softened at a temperature of about 100° C. Accordingly, the denture as described herein can be heated sufficiently in boiling water in order to become moldable when the user bites down onto the denture.

In certain embodiments, the multi-layer, heat moldable denture described herein is formed of high-impact thermoplastic material configured to harden or set in from about 1 minute to about 10 minutes, from about 2 minutes to about 8 minutes, or from about 2 minutes to about 6 minutes at a temperature below 40° C., for example, room temperature (20-24° C.). In preferred embodiments, the heat moldable denture material is configured to be reformed by repeating the heating (e.g., softening in boiling water). In an embodiment, the multi-layer, heat moldable denture as described herein takes about 2-5 minutes to harden or set at room temperature. As such, a user has a work time sufficient to fit the denture comfortably before it hardens or sets.

In certain embodiments, the first portion or layer, gingival portion or layer, and (if present) the at least one additional portion or layer are configured to be formed to fit the mouth of a user when the user bites down on the softened heat moldable material, e.g., softened by boiling. In certain embodiments, the denture as described herein is injection molded or 3D printed in layers of high-impact thermoplastic material.

As used herein, “high-impact” refers to a thermoplastic or heat moldable material that has a fracture toughness of at least about 1.0 MPa·m^{1/2} . Fracture toughness tests, e.g., ISO 17281:2018 or ASTM E1820, can be used to determine a plastic material's resistance to crack propagation and therefore fracture. In certain embodiments, the high-impact thermoplastic or heat moldable material used in the dentures as described herein has a fracture toughness of from about 1.0 MPa·m^{1/2} to about 2.5 MPa·m^{1/2}, from about 1.1 MPa·m^{1/2} to about 2.5MPa·m^{1/2}, from about 1.2 MPa·m^{1/2} to about 2.5 MPa·m^{1/2}, from about 1.3 MPa·m^{1/2} to about 2.5MPa·m^{1/2}, from about 1.4 MPa·m^{1/2} to about 2.5 MPa·m^{1/2}, from about 1.5 MPa·m^{1/2} to about 2.5MPa·m^{1/2}, from about 1.6 MPa·m^{1/2} to about 2.5MPa·m^{1/2} , from about 1.7 MPa·m^{1/2} to about 2.5MPa·m^{1/2}, from about 1.8 MPa·m^{1/2} to about 2.5 MPa·m^{1/2}, from about 1.9 MPa·m^{1/2} to about 2.5MPa·m^{1/2}, from about 2.0 MPa·m^{1/2} to about 2.5 MPa·m^{1/2}, from about 2.1 MPa·m^{1/2} to about 2.5MPa·m^{1/2}, from about 2.2 MPa·m^{1/2} to about 2.5 MPa·m^{1/2}, from about 2.3 MPa·m^{1/2} to about 2.5 MPa·m^{1/2}, or from about 2.4 MPa·m^{1/2} to about 2.5 MPa·m^{1/2}; or from about 1.0 MPa·m^{1/2} to about 2.4 MPa·m^{1/2}, from about 1.0 MPa·m^{1/2} to about 2.3 MPa·m^{1/2}, from about 1.0 MPa·m^{1/2} to about 2.2MPa·m^{1/2}, from about 1.0 MPa·m^{1/2} to about 2.1 MPa·m^{1/2}, from about 1.0 MPa·m^{1/2} to about 2.0MPa·m^{1/2}, from about 1.0 MPa·m^{1/2} to about 1.9 MPa·m^{1/2}, from about 1.0 MPa·m^{1/2} to about 1.8MPa·m^{1/2}, from about 1.0 MPa·m^{1/2} to about 1.7 MPa·m^{1/2} or a combination thereof using ISO 17281:2018 or ASTM E1820.

In certain embodiments, the high-impact thermoplastic or heat moldable material as used in the denture described herein has a Charpy impact strength of about 5 kJ/m² or more at 23° C., 4.2 J, as measured in accordance with ISO 179/1. In certain embodiments, the high-impact thermoplastic or heat moldable material has a Charpy impact strength of about 6 kJ/m² or more, of about 7 kJ/m² or more, of about 8 KJ/m² or more, of about 9 kJ/m² or more, of about 10 kJ/m² or more, of about 11 kJ/m² or more, of about 12 kJ/m² or more; or from about 5 kJ/m² to about 12kJ/m² , from about 6 kJ/m² to about 12kJ/m² , from about 7 kJ/m² to about 12 kJ/m², from about 8 kJ/m² to about 12kJ/m², from about 9 kJ/m² to about 12kJ/m² , from about 10 kJ/m² to about 12kJ/m² , or from about 11 kJ/m² to about 12 kJ/m² at 23° C., 4.2 J, as measured in accordance with ISO 179/1.

It is expressly contemplated that when softened by heating the first portion or layer and, when present, the intermediate portion or layer, will not be as soft and pliable as the gingival portion when softened by heating. However, when cooled and hardened, the entire denture will be approximately the same range of at least one of fracture toughness, impact strength, or elastic modulus.

ISO 527-2 specifies the test conditions for determining the tensile modulus (also known as elastic modulus or Young's modulus) properties of molding and extrusion plastics and can be used to measure the properties of high-impact thermoplastic resins, i.e., thermoplastic or heat moldable materials as described herein that, as a finished material, is capable of being repeatedly softened by heating and hardened by cooling.

In any of the aspects or embodiments described herein, the first portion or layer and, when present, the intermediate portion or layer, when softened by heating is from about 10 to about 100 MPa, from about 15 to about 100 MPa, from about 20 to about 100 MPa, from about 25 to about 100 MPa, from about 30 to about 100 MPa, from about 35 to about 100 MPa, from about 40 to about 100 MPa, from about 45 to about 100 MPa, from about 50 to about 100 MPa, from about 55 to about 100 MPa, from about 60 to about 100 MPa, from about 65 to about 100 MPa, from about 70 to about 100 MPa, from about 75 to about 100 MPa, from about 80 to about 100 MPa, from about 85 to about 100 MPa, from about 90 to about 100 MPa, from about 95 to about 100 MPa measured in accordance with ISO 527-2.

In any of the aspects or embodiments described herein, when cooled and hardened the first portion or layer and, when present, the intermediate portion or layer has an elastic modulus of from about 100 to about 4800 MPa, from about 200 to about 4800 MPa, from about 300 to about 4800 MPa, from about 400 to about 4800 MPa, from about 500 to about 4800 MPa, from about 600 to about 4800 MPa, from about 700 to about 4800 MPa, from about 800 to about 4800 MPa, from about 900 to about 4800 MPa, from about 1000 to about 4800 MPa, from about 1100 to about 4800 MPa, from about 1200 to about 4800 MPa, from about 1300 to about 4800 MPa, from about 1400 to about 4800 MPa, from about 1500 to about 4800 MPa, from about 1600 to about 4800 MPa, from about 1700 to about 4800 MPa, from about 1800 to about 4800 MPa, from about 1900 to about 4800 MPa, from about 2000 to about 4800 MPa, from about 2100 to about 4800 MPa, from about 2200 to about 4800 MPa, from about 2300 to about 4800 MPa, from about 2400 to about 4800 MPa, from about 2500 to about 4800 MPa, from about 2600 to about 4800 MPa, from about 2700 to about 4800 MPa, from about 2800 to about 4800 MPa, or more than about 4800 MPa measured in accordance with ISO 527-2.

In any of the aspects or embodiments described herein, the gingival layer when softened by heating has an elastic modulus from about 1 to about 60 MPa, from about 2 to about 60 MPa, from about 3 to about 60 MPa, from about 4 to about 60 MPa, from about 5 to about 60 MPa, from about 6 to about 60 MPa, from about 7 to about 60 MPa, from about 8 to about 60 MPa, from about 9 to about 60 MPa, from about 10 to about 60 MPa, from about 11 to about 60 MPa, from about 12 to about 60 MPa, from about 13 to about 60 MPa, from about 14 to about 60 MPa, from about 15 to about 60 MPa, from about 16 to about 60 MPa, from about 17 to about 60 MPa, from about 18 to about 60 MPa, from about 19 to about 60 MPa, from about 20 to about 60 MPa, from about 21 to about 60 MPa, from about 22 to about 60 MPa, from about 23 to about 60 MPa, from about 24 to about 60 MPa, from about 25 to about 60 MPa, from about 26 to about 60 MPa, from about 27 to about 60 MPa, from about 28 to about 60 MPa, from about 29 to about 60 MPa, from about 30 to about 60 MPa, from about 31 to about 60 MPa, from about 32 to about 60 MPa, from about 33 to about 60 MPa, from about 34 to about 60 MPa, from about 35 to about 60 MPa, from about 36 to about 60 MPa, from about 37 to about 60 MPa, from about 38 to about 60 MPa, from about 39 to about 60 MPa, from about 40 to about 60 MPa, from about 41 to about 60 MPa, from about 42 to about 60 MPa, from about 43 to about 60 MPa, from about 44 to about 60 MPa, from about 45 to about 60 MPa, from about 46 to about 60 MPa, from about 47 to about 60 MPa, from about 48 to about 60 MPa, from about 49 to about 60 MPa, from about 50 to about 60 MPa, or from 60 MPa to 80 MPa measured in accordance with ISO 527-2. In any of the aspects or embodiments described herein, when cooled and hardened the gingival portion or layer has an elastic modulus of from about 100 to about 4800 MPa, from about 200 to about 4800 MPa, from about 300 to about 4800 MPa, from about 400 to about 4800 MPa, from about 500 to about 4800 MPa, from about 600 to about 4800 MPa, from about 700 to about 4800 MPa, from about 800 to about 4800 MPa, from about 900 to about 4800 MPa, from about 1000 to about 4800 MPa, from about 1100 to about 4800 MPa, from about 1200 to about 4800 MPa, from about 1300 to about 4800 MPa, from about 1400 to about 4800 MPa, from about 1500 to about 4800 MPa, from about 1600 to about 4800 MPa, from about 1700 to about 4800 MPa, from about 1800 to about 4800 MPa, from about 1900 to about 4800 MPa, from about 2000 to about 4800 MPa, from about 2100 to about 4800 MPa, from about 2200 to about 4800 MPa, from about 2300 to about 4800 MPa, from about 2400 to about 4800 MPa, from about 2500 to about 4800 MPa, from about 2600 to about 4800 MPa, from about 2700 to about 4800 MPa, from about 2800 to about 4800 MPa, or more than about 4800 MPa measured in accordance with ISO 527-2.

In additional embodiments, the multi-layer, heat moldable denture comprises a first portion or layer comprising, consisting essentially of or consisting of a heat moldable material, and including at least one heat moldable tooth, and an additional layer having an adjustable surface area, wherein the additional layer is proximate to or affixed to the first portion or layer, and wherein when heated, the entire denture can be molded to the mouth of a user. In certain embodiments, the layer having an adjustable surface area includes a heat moldable palate portion, wherein the palate portion is configured to engage and conform to the hard palate of the user.

In an additional embodiment, the multi-layer, heat moldable denture as described herein comprises a first portion or layer comprising, consisting essentially of or consisting of a heat moldable material, and including at least one heat moldable tooth, and a heat moldable palate portion proximate to or affixed to the first portion or layer, and wherein when heated, the entire denture can be molded to the mouth of a user. In further embodiments, the surface area of the heat moldable palate portion is adjustable. In any aspect or embodiment, the tooth portion includes a plurality of teeth.

In an additional embodiment, the disclosure provides a multi-layer, heat moldable denture comprising a first portion or layer comprising, consisting essentially of or consisting of a high-impact, thermoplastic or heat-moldable material, wherein the first portion or layer includes at least one heat-moldable tooth; a gingival portion or layer comprising, consisting essentially of or consisting of a heat-moldable material positioned proximate to or affixed to the first portion or layer, and a heat moldable palate portion proximate to or affixed to at least one of the first portion or layer, the gingival portion or layer or a combination thereof. In certain embodiments the palate portion is contiguous with the gingival portion and formed of the same material.

In any aspect or embodiment described herein, the denture is an upper (i.e., maxilla) denture and includes a heat moldable palate portion that is ductile and malleable to be fitted to contours of the palate surface of the subject. In any aspect or embodiment described herein, the heat moldable palate portion is configured with features to provide at least one of improved positioning, fixation, stability or combination thereof to improve the occlusion of the teeth.

In any aspect or embodiment described herein, the heat moldable palate portion includes or is configured to have an adjustable surface area. The heat moldable palate portion surface, for instance, may be changed to contact and contour to patient tissue. As such, the material is not the only variable that can be adapted to accommodate the various shapes of the user's palate. In any aspect or embodiment described herein, the heat moldable palate portion is configured to be at least one of: expanded, contracted, flexed, folded, or moved in such a manner as to change the surface area of the heat moldable palate portion. In any aspect or embodiment, the adjustable surface area of the heat moldable palate portion is adjustable in a direction that includes at least one of vertical and horizontal. In certain embodiments, the heat moldable palate portion is formed of a stretchable high-impact thermoplastic material that allows for adjustment of the surface area when heated and can be readapted when reheated.

The heat moldable palate portion expands or otherwise deforms to maintain the dental occlusion of the user. Therefore, in any aspect or embodiment described herein, the teeth include an occlusion, wherein the occlusion may be maintained as the heat moldable palate portion surface area is adjusted.

For example, in any aspects or embodiments described herein, the heat moldable palate portion comprises at least one of: a post, dimple, a channel, a cut, a contoured surface, an accordion design, a tongue-shaped design, a jagged surface, a smooth surface, a flexible surface, a foldable surface, a perforated surface, an actuating surface, an expanding surface, and a changeable surface or other design element or combination thereof to facilitate adjustment of the surface area. The adjustable surface area of the heat moldable palate portion allows for accommodation of different anatomical morphologies further allowing the denture as described herein to securely and comfortably fit the mouth of substantially any user.

In certain embodiments, the heat moldable palate portion is designed to expand its surface area with a uniform or non-geodesic disruptive, contiguous, or non-contiguous surface that can expand and/or collapse using a variety of different configurations and designs. The surface area of the palate may expand using techniques that include but are not limited to cross-sections or lateral sections that look like speed bumps, pointed/non-pointed arches, radial circles or other shapes, accordion design, expandable or retractable levers or tongues, church steeple or rounded radius design, contoured or non-contoured to accomplish the ability to move material selectively to sections of the mouth that need fitting. The number of features, frequency used, and combination may vary across different embodiments. When the heat moldable palate portion is heated, becomes pliable, and comes in contact with the upper part of the mouth, the denture may be pushed, molded, and/or moved to expand or reduce in size to contour to the shape of a mouth of a user.

In any aspect or embodiment described herein, the disclosure provides a denture system comprising a denture as described herein, and a separate, heat moldable palate insert to improve denture spacing, positioning and/or comfort.

In any aspect or embodiment, the multi-layer, heat moldable denture as described herein comprises an intermediate heat moldable layer disposed between the first portion or layer (i.e., tooth portion or layer) and the gingival portion or layer such that the intermediate layer contacts the first and second portions or layers. In certain embodiments, all three portions or layers are connect to each other directly. In additional embodiments, one of the portions or layers is directly connected to another portion or layer but not another. For example, a first portion or layer (i.e., tooth portion or layer) maybe proximate to or in communication with a gingival portion or layer but not connected directly to a gingival layer.

As discussed above, when heated, for example, boiled in water, all portions or layers of the multi-layer, heat moldable denture described herein become flexible. In particular, the teeth also become flexible allowing them to fit into the opposing natural dentition or opposing denture. So, all layers move and flex and are moldable. Teeth and gingival layer flex, intermediate layer, and palate portion all flex and stretch allowing full adaptation to many different bites and mouth shapes and sizes, and allow customization for different bite radii, bite angle, and articulation of teeth, including rotation. Unlike conventional dentures, which do not contemplate the adaptation for teeth to be flexible as well when heated, this flexible tooth layer is what allows the described denture to be fit without the need for a dentist to help with the process. The denture as described herein, allows for an over-the-counter or dentist supplied product that confers a denture feel and function similar to a traditional denture but can be fitted quickly and conveniently at home or in a dentist's office.

In any aspect or embodiment, the gingival portion or layer is configured to be formed in the mouth of a user when the user bites down on the head moldable material. As would be understood by the skilled artisan, it is not desirable to have the first portion or layer comprising heat-moldable teeth to be as soft and pliable as the gingival portion or layer. As such, it is preferable that the gingival portion or layer be configured or comprised of a more pliable heat moldable material than the first portion or layer comprising the teeth such that the gingival portion or layer can be formed in the mouth of a user when the user bites down on the heat moldable material.

In any aspect or embodiment described herein, the high-impact thermoplastic or heat moldable material comprises a high impact high-impact thermoplastic or heat moldable material. In certain embodiments, the high impact high-impact thermoplastic or heat moldable material comprises an acrylic material, e.g., high impact acrylic denture resin. In certain embodiments, the high impact high-impact thermoplastic or heat moldable material comprises a mixture including a methyl methacrylate (MMA) monomer (e.g., a liquid), and polymethyl methacrylate (PMMA) powder. In certain embodiments, the mixture comprises at least one of a plasticizer, an emulsifier or a combination thereof.

In certain embodiments, the first portion or layer and/or the intermediate layer (if present) comprise a high impact high-impact thermoplastic or heat moldable material comprising a high impact acrylic denture resin. In certain embodiments the high-impact thermoplastic or heat moldable material of the first portion or layer and/or the intermediate layer (if present) comprise a mixture of an acrylic monomer, an acrylic polymer and at least one of a plasticizer, an emulsifier or a combination thereof.

In certain embodiments, the high-impact thermoplastic or heat moldable material of the first portion or layer and/or the intermediate layer (if present) comprises an acrylic monomer, e.g., MMA, at an amount of from about 1 ml to about 50 ml, from about 2 ml to about 25 ml or from about 2 ml to about 10 ml. In certain embodiments, the high-impact thermoplastic or heat moldable material of the first portion or layer and/or the intermediate layer (if present) comprises polymethyl methacrylate (PMMA) at an amount of from about 1 g to about 50 g, from about 2 g to about 25 g or from about 2 g to about 10 g.

In certain embodiments, the high-impact thermoplastic or heat moldable material of the first portion or layer and/or the intermediate layer (if present) comprises a plasticizer and/or emulsifier at an amount of from about 1 ml to about 15 ml, from about 1 ml to about 10 ml, or from about 1 ml to about 5 ml.

In a preferred embodiment, the color of the high-impact thermoplastic or heat moldable material of the first portion or layer is tooth-colored, e.g., white to off-white. In a preferred embodiment, the color of the high-impact thermoplastic or heat moldable material of the intermediate layer is gum or gingival colored, e.g., pink.

In any of the aspects or embodiments described herein, the plasticizer is a food grade plasticizer. In certain embodiments, the plasticizer is at least one of an adipate (e.g., bis(2-ethylhexyl) adipate (DEHA) or diisodecyl adipate (DIDA)), a citrate/citric acid ester, a benzoate (e.g., benzoate ester), a bio-based plasticizer (e.g., vegetable oil), sorbitol, glycerol, mannitol, sucrose, polyethylene glycol, glycerin, triacetin or a combination thereof. In certain embodiments, the citrate plasticizer is at least one of acetyl citrate, triethyl citrate (TEC), tributyl citrate, acetyl tributyl citrate (ATBC), tributyl O-acetylcitrate, tris (2-ethylhexyl) O-acetyl citrate or a combination thereof (commercially available from, e.g., Jobachem GmbH, Germany).

As a product of the addition, even after the resin is initially set, the material may be reheated in boiling water to become pliable, again, (e.g., to be moved around or otherwise adjusted).

In any of the aspects or embodiments described herein, the emulsifier is a food grade emulsifier. In certain embodiments, the emulsifier is at least one of a phospholipid, e.g., lecithin, carrageenan, guar gum, carboxymethylcellulose, mono-glyceride, diglyceride, xanthan gum, gum Arabic, polysorbate or a combination thereof.

In certain additional embodiments, the multi-layer, heat formable denture as described herein includes a high-impact thermoplastic or heat moldable material that comprises at least one of (poly)ethylene (e.g., polyethylene vinyl acetate), polycarbonate, polycaprolactone or a combination thereof. In certain embodiments, the gingival portion or layer comprises a high-impact thermoplastic or heat moldable material that comprises at least one of (poly)ethylene (e.g., polyethylene vinyl acetate), polycarbonate, polycaprolactone or a combination thereof. The high-impact thermoplastic or heat moldable material of the gingival layer must adhere to the first portion or layer including teeth structures and, when warmed, must be stretchable and soft enough to form a comfortable fit when the user bites down.

As described above, a multi-layer, heat moldable denture comprising the high-impact thermoplastic or heat moldable materials will become thermoplastic or heat moldable at a temperature of from about 40° C. to about 100° C.

In some examples, the ductility of the layer ranges from 50% to 100%, 200%, 300%, 400%, 500%, 600%, 700%, 800%, 900%, 1000% or more. In certain embodiments, when warm, the hardness of the material typically measures around 20 when using a 00 durometer (i.e., Shore Hardness) scale. Once cooled, the layer maintains its shape to provide a comfortable fit.

Shore hardness scales have different hardness ranges. The Shore 00 scale measures ultra-soft materials, the Shore A scale measures the hardness of soft to semi-rigid materials, and the Shore D scale measures extremely rigid materials. Shore 00, Shore A, and Shore D are the most commonly used scales for measuring the hardness of rubber, plastics, silicone, and other polymers, and can be measured using ASTM D2240 or ISO 48-4. The Shore D (Durometer Scale) hardness measures the resistance of a material to indentation, specifically for harder, more rigid materials like hard plastics and elastomers, using a scale from 0 to 100, where higher numbers indicate greater hardness.

In certain embodiments, when softened by heating the high-impact thermoplastic or heat moldable first layer or portion including at least one tooth-like structure, and if present, the intermediate portion or layer have a hardness of from 40 to about 80 on the Shore A scale, and when cooled and hardened have a hardness of from about 40 to about 90 on the Shore D scale as determined by ASTM D2240 or ISO 48-4. In certain embodiments, when softened by heating the high-impact thermoplastic or heat moldable gingival layer or portion has a hardness of from about 10 on the Shore 00 scale to about 50 on the Shore A scale or from about 20 on the Shore A scale to about 40 on the Shore A scale, and when cooled and hardened has a hardness of from about 40 to about 90 on the Shore D scale as determined by ASTM D2240 or ISO 48-4.

In any aspect or embodiment described herein, the high-impact thermoplastic or heat moldable material of the first portion or layer is the same as the high-impact thermoplastic or heat moldable material of the gingival portion or layer. In any aspect or embodiment described herein, the high-impact thermoplastic or heat moldable material of the first portion or layer is different from the high-impact thermoplastic or heat moldable material of the gingival portion or layer. In still an additional embodiment, the high-impact thermoplastic or heat moldable material of the first portion or layer is the same as the intermediate portion or layer but is different from the high-impact thermoplastic or heat moldable material of the gingival portion or layer.

The heat moldable feature allows for customization directly in a person's mouth by softening, reforming, and then hardening to the new shape or position once it cools. As described, the denture softens and deforms to adapt to different bites, mouth shapes and sizes. Thus, in certain embodiments, the multi-layer, heat moldable denture described herein is configured to fit a plurality of different mouth sizes. In certain embodiments, the denture as described herein is formed into a plurality of standard, differently sized dentures. Thus, additional embodiments, the denture as described herein comprises a universal fit, boil-and-bite denture.

In any aspect or embodiment described herein, the first portion or layer comprises a plurality of adjustable teeth. In any aspect or embodiment described herein, the plurality of adjustable teeth are individually or collectively adjustable; and/or deformable; and/or pliable or reformable. In any aspect or embodiment described herein, the plurality of adjustable teeth are each formed of a heat moldable high-impact thermoplastic polymer material. The occlusal portion of the teeth of the multi-layer, heat moldable denture described herein is also flexible allowing the teeth to widen and narrow and also go up and down or even go into a helical shape if needed, this full adaptation allows this denture to adapt to nearly every bite without the need for a drill to reshape or without the need to have to add additional resins thus allowing this to be self-fit without the help from a dental professional.

An advantage of the dentures described herein is that the occlusal portion of the teeth is also flexible allowing the teeth to widen and narrow, as well as go up and down or rotate if needed. This full adaptation allows the denture to conform to nearly every bite without the need for a drill to reshape or add additional resins, allowing it to be fit by the user without help from a dental professional. Accordingly, the denture as described herein, allows the user's bite line up and fit close enough for the user to comfortably chew and smile. Another significant advantage of the fully heat moldable denture as described herein is that it allows for establishment of flat plane occulsion on posterior teeth to make it easier for universal fit and chew.

In any aspect or embodiment described herein, the high-impact thermoplastic or heat moldable material of the first portion or layer has a higher elastic modulus when boiled than the high-impact thermoplastic or heat moldable material of the gingival layer; however, once cooled, the first portion or layer and the gingival portion or layer have approximately the same elastic modulus.

In certain embodiments, the first portion or layer comprises a high-impact thermoplastic or heat moldable material and includes at least one tooth structure formed of, e.g., a high impact resin as described herein, e.g., in a white color; a gingival portion or layer overmolded onto the first, e.g., in a pink gum color. Optionally, an intermediate portion or layer is overmolded onto first portion or layer, wherein the intermediate portion or layer is also in pink. As described above, it is contemplated that the gingival portion or layer allows for full adaptation to the gum tissue. The injection molded first and (when present) intermediate layers allow the teeth to be fully flexing (formable) to adjust to any arch whether the subject has their remaining dentition on the opposite arch or if lining up to an opposing denture.

In certain embodiments, the multi-layer, heat moldable denture as described herein includes sufficient material in the gingival layer to allow the user to trim any excess depending on the amount needed to fit properly and comfortably. Accordingly, the multi-layer, heat moldable denture described herein is able to fit nearly any size and shape mouth by virtue of the heat moldable material, design, size, and palate design.

In any aspect or embodiment described herein, the denture is an upper (i.e., maxilla) denture and includes a heat moldable palate portion that is ductile and malleable to be fitted to contours of the palate surface of the subject. In any aspect or embodiment described herein, the heat moldable palate portion is configured with features to provide at least one of improved positioning, fixation, stability or combination thereof to improve the occlusion of the teeth. In any aspect or embodiment described herein, the heat moldable palate portion comprises at least one of a post, cut, channel, dimple or combination thereof that allows the heat moldable palate portion to expand, stretch, and/or adhere to a subject's palate anatomy to improve the occlusion of the teeth.

In any aspect or embodiment described herein, the denture is a lower (i.e., mandible) denture. In any aspect or embodiment described herein, the denture is an upper (i.e., maxilla) denture. In any aspect or embodiment described herein, the denture further comprises a separate, heat moldable palate insert to improve denture positioning and/or comfort.

In any aspect or embodiment described herein, the disclosure provides a multi-layer, high-impact, thermoplastic or heat moldable denture comprising a first component comprising a first portion or layer including at least one tooth-like structure as described herein, wherein the first component comprises a high-impact thermoplastic or heat moldable acrylic resin, and a second component comprising a gingival portion or layer, wherein the second component comprises a high-impact, thermoplastic or heat moldable material, for example, a polycaprolactone. In certain embodiments, the first component and second component are configured to adhere to each other. In certain additional embodiments, the first component and the second component are reversibly affixed with an adhesive. Commercial denture adhesives are available including, e.g., Fixodent®, Polygrip® and others, which could be used in association with these embodiments. In an additional embodiment, the first component and second component are permanently affixed with an adhesive, e.g., an acrylic adhesive or thermoplastic adhesive. As such, in such embodiments, the entire denture is heat moldable to the mouth of practically any user.

In an additional embodiment, the description provides a multi-layer, heat moldable denture comprising: a first portion or layer comprising a heat moldable acrylic resin material, wherein the first portion or layer includes at least one heat moldable tooth; an intermediate portion or layer comprising a heat moldable acrylic resin material that is overmolded and affixed to the first portion or layer; and a gingival portion or layer comprising polycaprolactone affixed to the intermediate portion or layer, wherein the denture comprises a heat moldable, expandable palate portion optionally comprising polycaprolactone, and wherein the gingival layer is fitted to contours of gingival tissue of a subject, and the palate portion is fitted to contours of palate tissue of the subject.

In certain embodiments, the heat moldable acrylic resin of the first portion or layer comprises an MMA monomer, a PMMA polymer, and at least one of a plasticizer, emulsifier or combination thereof. In certain embodiments, the plasticizer is a citrate/citric acid ester plasticizer. In certain embodiments, the citrate/citric acid ester plasticizer is at least one of acetyl citrate, triethyl citrate (TEC), tributyl citrate, acetyl tributyl citrate (ATBC), tributyl 2-acetylcitrate, tributyl O-acetyl citrate, tris (2-ethylhexyl) O-acetyl citrate or a combination thereof.

### Kits

An embodiment of a denture as described herein include, for example, an over-the-counter or dentist supplied kit that allows a denture to feel and function similar to a traditional denture. The denture may be fitted quickly and conveniently at home or at a dentist's office just similar to a boil-and-bite mouthpiece. When boiled in water, the entire denture teeth will flex, and the attached, stretchable layer flexes and stretches to adapt to most mouth shapes and different occlusal patterns. Put another way, the denture molds and flexes to take most mouth shapes. Different sized dentures (e.g., small, medium, large, etc.) may be sold to accommodate different mouth sizes and various shapes, generally. The composition stiffens or hardens in the patient's mouth or cool water in around one to ten minutes and will maintain its shape. Where desired, the denture may be re-heated to take another shape or to adjust to changes in a palate over time. Injection molding processes enable cost efficient mass production. As described herein, three-dimensional printing processes may be used.

Thus, in an additional aspect, the disclosure provides kits comprising a container and a denture as described herein. For example, out of the box, the dentures of an embodiment are hard like standard dentures and has a comfort layer which allows for the stretching and full adaptation for proper fit. Once submerged in boiling water for around 30 to 120 seconds, the dentures become flexible and stetchable to form to the user's mouth. After about 1-10 minutes of setting (e.g., with or without submerging in cool water), the dentures maintain their shape and harden. If at some point later on the user desires to refit the dentures, they can easily re-boil the dentures and form to their mouth again.

In any aspect or embodiment described herein, the denture is a lower (i.e., mandible) denture. In any aspect or embodiment described herein, the denture is an upper (i.e., maxilla) denture. In any aspect or embodiment described herein, the denture further comprises a separate, heat moldable palate insert to improve denture positioning and/or comfort.

In any aspect or embodiment described herein, the disclosure provides a multi-layer, high-impact, thermoplastic or heat moldable denture comprising a first component comprising a first portion or layer including at least one tooth-like structure as described herein, wherein the first component comprises a high-impact thermoplastic or heat moldable acrylic resin, and a second component comprising a gingival portion or layer, wherein the second component comprises a high-impact, thermoplastic or heat moldable material, for example, a polycaprolactone. In certain embodiments, the first component and second component are configured to adhere to each other. In certain additional embodiments, the first component and the second component are reversibly affixed with an adhesive. Commercial denture adhesives are available including, e.g., Fixodent®, Polygrip® and others, which could be used in association with these embodiments. In an additional embodiment, the first component and second component are permanently affixed with an adhesive, e.g., an acrylic adhesive or thermoplastic adhesive. As such, in such embodiments, the entire denture is heat moldable to the mouth of practically any user.

### Methods of Manufacture

In an additional aspect, the disclosure provides a method of manufacturing a multi-layer, heat moldable denture as described herein comprising the steps of providing or preparing a high-impact thermoplastic or heat moldable material as described herein; depositing a first layer of high-impact thermoplastic or heat moldable material, wherein the first layer includes at least one heat moldable and adjustable tooth-like structure (herein, a “tooth” or, if plural, “teeth); and depositing proximate to or on top of the first layer, a gingival layer, wherein the gingival layer comprises a high-impact thermoplastic or heat moldable material. As discussed above, all layers (e.g., including the teeth layer) are flexible when heated to accommodate any size or shape bite anatomy.

In any aspect or embodiment described herein, the high-impact thermoplastic or heat moldable material comprises a high impact high-impact thermoplastic or heat moldable material. In certain embodiments, the high impact high-impact thermoplastic or heat moldable material comprises an acrylic material, e.g., high impact acrylic denture resin. In certain embodiments, the high impact high-impact thermoplastic or heat moldable material comprises a mixture including a methyl methacrylate (MMA) monomer (e.g., a liquid), and polymethyl methacrylate (PMMA) powder. In certain embodiments, the mixture comprises at least one of a plasticizer, an emulsifier or a combination thereof.

In certain embodiments, the first portion or layer and/or the intermediate layer (if present) comprise a high impact high-impact thermoplastic or heat moldable material comprising a high impact acrylic denture resin. In certain embodiments the high-impact thermoplastic or heat moldable material of the first portion or layer and/or the intermediate layer (if present) comprise a mixture of an acrylic monomer, an acrylic polymer and at least one of a plasticizer, an emulsifier or a combination thereof.

In certain embodiments, the high-impact thermoplastic or heat moldable material of the first portion or layer and/or the intermediate layer (if present) comprises an acrylic monomer, e.g., MMA, at an amount of from about 1 ml to about 50 ml, from about 2 ml to about 25 ml or from about 2 ml to about 10 ml. In certain embodiments, the high-impact thermoplastic or heat moldable material of the first portion or layer and/or the intermediate layer (if present) comprises polymethyl methacrylate (PMMA) at an amount of from about 1 g to about 50 g, from about 2 g to about 25 g or from about 2 g to about 10 g.

In certain embodiments, the high-impact thermoplastic or heat moldable material of the first portion or layer and/or the intermediate layer (if present) comprises a plasticizer and/or emulsifier at an amount of from about 1 ml to about 15 ml, from about 1 ml to about 10 ml, or from about 1 ml to about 5 ml.

In a preferred embodiment, the color of the high-impact thermoplastic or heat moldable material of the first portion or layer is tooth colored (e.g., white to off-white). In a preferred embodiment, the color of the high-impact thermoplastic or heat moldable material of the intermediate layer is gum colored (e.g., pink).

In any of the aspects or embodiments described herein, the plasticizer is a food grade plasticizer. In certain embodiments, the plasticizer is at least one of an adipate (e.g., bis(2-ethylhexyl) adipate (DEHA) or diisodecyl adipate (DIDA)), citrate/citric acid ester, a benzoate (e.g., benzoate ester), a bio-based plasticizer (e.g., vegetable oil), sorbitol, glycerol, mannitol, sucrose, polyethylene glycol, glycerin, triacetin or a combination thereof. In certain embodiments, the citrate plasticizer is at least one of acetyl citrate, triethyl citrate (TEC), tributyl citrate, acetyl tributyl citrate (ATBC), tributyl 2-acetylcitrate, tributyl O-acetyl citrate, tris (2-ethylhexyl) O-acetyl citrate or a combination thereof (commercially available from, e.g., Jobachem GmbH, Germany).

In any of the aspects or embodiments described herein, the emulsifier is a food grade emulsifier. In certain embodiments, the emulsifier is at least one of a phospholipid, e.g., lecithin, carrageenan, guar gum, carboxymethylcellulose, mono-glyceride, diglyceride, xanthan gum, gum Arabic, polysorbate or a combination thereof.

In certain additional embodiments, the multi-layer, heat formable denture as described herein includes a high-impact thermoplastic or heat moldable material that comprises at least one of (poly)ethylene (e.g., polyethylene vinyl acetate), polycarbonate, polycaprolactone or a combination thereof. In certain embodiments, the gingival portion or layer comprises a high-impact thermoplastic or heat moldable material that comprises at least one of (poly)ethylene (e.g., polyethylene vinyl acetate), polycarbonate, polycaprolactone or a combination thereof. The high-impact thermoplastic or heat moldable material of the gingival layer must adhere to the first portion or layer including teeth structures and, when warmed, must be stretchable and soft enough to form a comfortable fit when the user bites down.

In preferred embodiments, the gingival layer is ductile and malleable when sufficiently warmed such that it can be stretched and fitted to contours of gingival and/or palate surface of a subject. In any aspects or embodiments described herein, the gingival layer may be configured to include an expandable heat moldable palate portion. In certain embodiments, the heat moldable palate portion has an adjustable surface area as described herein. Therefore, when the denture is heated, the heat moldable palate portion expands or otherwise deforms in order to maintain the dental occlusion of the user.

In certain embodiments, the heat moldable palate portion comprises channels, cuts, folds, or other design elements to facilitate expansion of the surface area. The design elements and layers may allow the layer(s) to stretch side-to-side, as well as up and down. The denture system thus provides a boil-and-bite method that allows high-impact thermoplastic resin and stretch to conform to different mouth shapes.

When a user stretches the palate, that portion stretches while the rest of the dimensions may be maintained. If palate of a user is relatively deep, the user may manipulate the material to reach the user's palate tissue. For instance, a user may push up on the heat moldable palate portion of the denture to stretch it upwards towards the palate tissue. Alternatively, if the palate is shallow, the user may push less. The layer(s) may be stretched to accommodate shallow, wide or narrow palates.

In this manner, the denture enables a user to change a surface area of a palate portion with or without changing an occlusion (e.g., shifting of teeth). The stretched material then cools to a desired hardness. The teeth may be made wide or narrow to match the mouth of a user without changing the palate.

In any aspect or embodiment described herein, the depositing steps are performed by injection molding or 3D printing or a combination thereof.

In certain embodiments, the method includes a step of depositing an intermediate layer comprising a high-impact thermoplastic or heat moldable material onto the first layer prior to depositing the gingival layer. In certain embodiments, the first layer and intermediate layer (if present) are formed of a first high-impact thermoplastic or heat moldable material. In certain embodiments, the gingival layer is formed of a second high-impact thermoplastic or heat moldable material that is softer and more pliable when warmed as compared to the first. As discussed above, and advantage of the present denture and method of manufacture, is that the entire denture, including the teeth, are heat moldable such that the denture can be easily and comfortably fit to the natural dentition or opposing denture of any user. The teeth and stretchable gingival layer flexes and stretches to enable full adaptation to many different bites and mouth shapes and sizes without the need for a dentist to help with the process.

In certain embodiments, the method of manufacturing a multi-layer, heat moldable denture as described herein comprises the steps of providing or preparing a high-impact thermoplastic or heat moldable material as described herein; molding a first layer comprising a first high-impact thermoplastic or heat moldable material, wherein the first layer includes at least one heat moldable and adjustable tooth-like structure (herein, a “tooth” or, if plural, “teeth); and overmolding onto the first layer, a gingival layer comprising a high-impact thermoplastic or heat moldable material. In preferred embodiments, the gingival layer is ductile and malleable when sufficiently warmed such that it can be stretched and fitted to contours of gingival and/or palate surface of a subject. In any aspect or embodiment described herein, the molding step and overmolding step is performed by at least one of injection molding, 3D printing or a combination thereof.

While certain embodiments may include two layers, it is contemplated that the multi-layer, heat moldable denture described herein comprises 3 or more layers of high-impact thermoplastic or heat moldable material. In certain embodiments, the method of manufacturing a multi-layer, heat moldable denture as described herein comprises the steps of providing or preparing a high-impact thermoplastic or heat moldable material as described herein; molding a first layer comprising a first high-impact thermoplastic or heat moldable material, wherein the first layer includes at least one heat moldable and adjustable tooth-like structure (herein, a “tooth” or, if plural, “teeth); over molding an intermediate layer comprising a high-impact thermoplastic or heat moldable material; and over molding onto the intermediate layer, a gingival layer comprising a high-impact thermoplastic or heat moldable material. In preferred embodiments, the gingival layer is ductile and malleable when sufficiently warmed such that it can be stretched and fitted to contours of gingival and/or palate surface of a subject. In any aspect or embodiment described herein, the molding and over molding steps is performed by at least one of injection molding, 3D printing or a combination thereof.

In any of the aspects or embodiments described herein, the first layer is a white high-impact thermoplastic acrylic material, the intermediate layer (if present) is a pink high-impact thermoplastic acrylic material, and the gingival layer is a pink high-impact thermoplastic material.

In any aspect or embodiment described herein, the first layer comprises a plurality of high-impact thermoplastic or heat moldable teeth. In any aspect or embodiment described herein, the plurality of high-impact thermoplastic or heat moldable are individually or collectively adjustable, deformable, pliable or reformable. It is contemplated that any aspect of tooth (or teeth) geometry or position can be adjusted, including angle, articulation and rotation to fit comfortably with opposing dentition.

In any aspect or embodiment described herein, the denture is an upper (i.e., maxilla) denture and the gingival layer includes a heat moldable palate portion as described herein that is ductile and malleable to be fitted to contours of the palate surface of the subject. In any aspect or embodiment described herein, the heat moldable palate portion is configured with features to provide at least one of improved positioning, fixation, stability or combination thereof to improve the occlusion of the teeth. In any aspect or embodiment described herein, the heat moldable palate portion comprises at least one of a post, cut, channel, dimple or combination thereof that allows the heat moldable palate portion to expand, stretch, and/or adhere to a subject's palate anatomy to improve the occlusion of the teeth.

As described herein, the gingival portion or layer is configured to be softened in hot water, and designed to be conformed to the mouth of a user when the user bites down on the heat moldable material (e.g., by warming the denture in boiling water; enabling the user to bite into the softened gingival layer). The gingival layer is configured to fit a plurality of different mouth sizes. The multi-layer, heat moldable denture described herein thus comprises a universal fit, boil-and-bite denture. The boil-and-bite denture may be sold over-the-counter or by a dentist. The apparatus may comprise one of a plurality of standard, differently sized dentures. The denture, including the gingival layer, is configured to harden in between one and ten minutes. The denture can be reformed by repeating the step of warming in boiling water.

In certain embodiments, the multi-layer, heat moldable denture as described herein is manufactured using injection molding processes. For example, during manufacture by injection molding, a high-impact thermoplastic or heat moldable material for each layer is prepared by mixing the components, e.g., liquid acrylic monomer, powder acrylic polymer, and plasticizer; heating to create a homogeneous resin, and allowing to set or harden. The hardened material is pelletized, and the pellets are put into an injection molding machine to form each respective layer. For example, a first layer may be injection molded, wherein the first layer includes high-impact thermoplastic or heat moldable tooth-colored teeth-like structures. The teeth may be formed in one piece using injection molded, tooth colored, e.g., white to off-white, acrylic.

An additional gum colored, e.g., pink, gingival layer may be injection molded onto the first layer. In certain embodiments, the gingival layer includes a heat moldable palate portion. The flexible and expanding properties of the gingival layer, including a heat moldable palate portion may be adapted to fit the top surface of a mouth. Accordingly, the entire denture is moldable and can be shaped with heating. The denture may further be reshaped after setting by reintroducing the denture to boiling water and repeating the boil-and-bit process.

The high-impact thermoplastic denture as described herein can be fitted by the patient in about five minutes. For example, a patient may heat an upper or lower denture into boiling water for about 30-120 seconds. In an exemplary embodiment, the multi-layer, heat moldable denture as described herein is heated from about 30 seconds to 180 seconds at a temperature of between from about 60° C. to about 115° C., preferably between from about 43° C. to about 115° C., preferably at around 100° C. In any aspect or embodiment described herein, the multi-layer, heat moldable denture as described herein is heated to a temperature of about 80° C. for about 30-180 seconds in order to become malleable.

The patient may slide their thumb up to hold denture at roof of their mouth and use their fingers to push the denture firmly against their tissue. If the front teeth protrude more than desired, the patient may push them back. The patient may close their mouth and use a swallowing technique to create suction while pushing their thumb towards roof of mouth for about 90 seconds. The patient attempts to create a tight seal between denture and the roof of their mouth accomplished by swallowing to create suction. The teeth layer lines up with the opposing dentition, and the palate gets adjusted for proper fit, and the flexible gingival layer captures the undercuts and extends to give best retention and comfort for the patient. The patient can also cut or tear away the flexible gingival layer and move it or replace it if needed. Once complete, the denture may be placed into a bowl of cold water for about 10 seconds or more to set. The process may be repeated if a good fit is not initially achieved. Similar processes may be used for both upper and lower dentures.

Once cooled, the high-impact thermoplastic or heat moldable acrylic material retains its shape in the hardened form. Custom formable dentures may accommodate wide ranges of mouth dimensions. The users can also reshape the denture at a later point in time, if desired. The material may also be formed as sheets, inserts, e.g., a palate insert, spacer or in other forms that can be bent to apply structural supports for various applications such as splints, more durable mouth guards, sleep apnea devices, retainers, etc.

In certain embodiments, the multi-layer, heat moldable denture described herein may be mass produced using injection molding processes to produce an over-the counter-denture available for home or dentist fitting and with or without a prescription. The denture is moldable and may be shaped with heating. The denture may further be reshaped after setting. The moldable denture system may include multiple layers (e.g., at least two layers). An heat moldable, expandable palate portion (e.g., comprising a gingival and/or an additional layer) of the denture may move up, down, or horizontally to accommodate different palatal vaults. The palatal vault design may move independently without moving the teeth out of alignment. As such, the independently shapeable palate may preserve the occlusion while expanding or contracting.

### EXAMPLES

With reference to the Figures, which illustrate exemplary aspects and embodiments of the multi-layer, high-impact thermoplastic or heat moldable denture article described herein (note: like numerals represent like features).

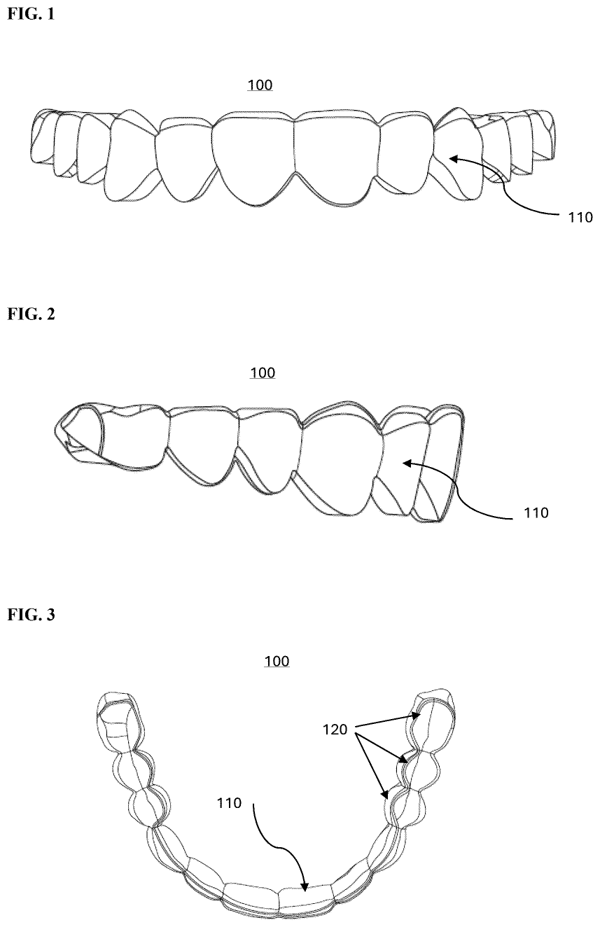

FIGS. 1-4 illustrate views of a first portion or layer 100 and an upper denture (maxilla) comprising a high-impact thermoplastic or heat moldable material as described herein, and includes at least one tooth-like structure 110. In certain embodiments, the denture comprises a first portion or layer 100 comprising a plurality of teeth 110. As described herein, the first portion or layer, including the teeth, is entirely heat moldable and is formed of a high-impact thermoplastic or heat moldable material. FIG. 1 is a front view of the first portion or layer 100. The teeth 110 have an apical surface (chewing surface) and a basal surface, which is proximate to or affixed to an overmolded gum-like layer (gingival layer or intermediate layer as described herein) also comprising high-impact thermoplastic or heat moldable material. FIG. 2 provides a side view of the first portion or layer 100 comprising at least one tooth-like structure 110.

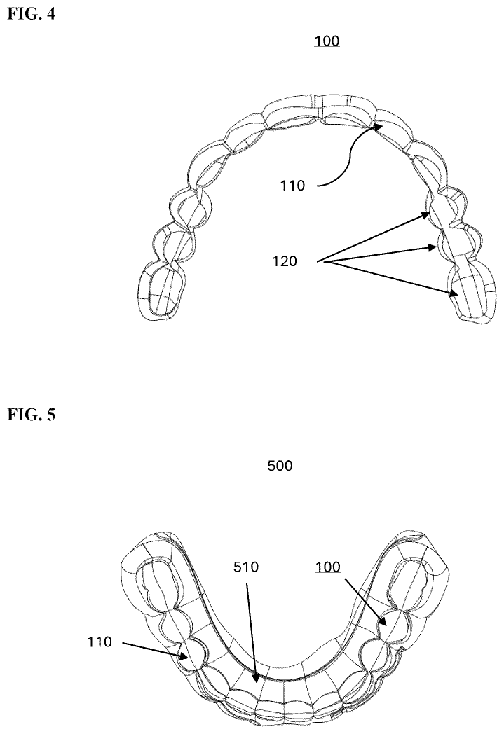

FIGS. 3 and 4 provide top and bottom views, respectively, of the first portion or layer 100 comprising at least one tooth-like structure 110. In certain embodiments, the apical portion of at least one of the tooth-like structures is configured to include a bracket structure 120 to promote or facilitate a strong and stable interaction of the first portion or layer (i.e., the tooth layer) with the adjoining layer (gingival and/or intermediate). The bracket structure helps to maintain proper alignment of the occlusal portion of the tooth. In certain embodiments, the bracket structure 120 extends inwardly (e.g., approximately perpendicularly) from the plane (or axis) of the tooth. In a preferred embodiment, the bracket structure 120 is thin, e.g., 2 mm or less, so as to minimize deformation of the gum-like layers and to promote a comfortable denture fit.

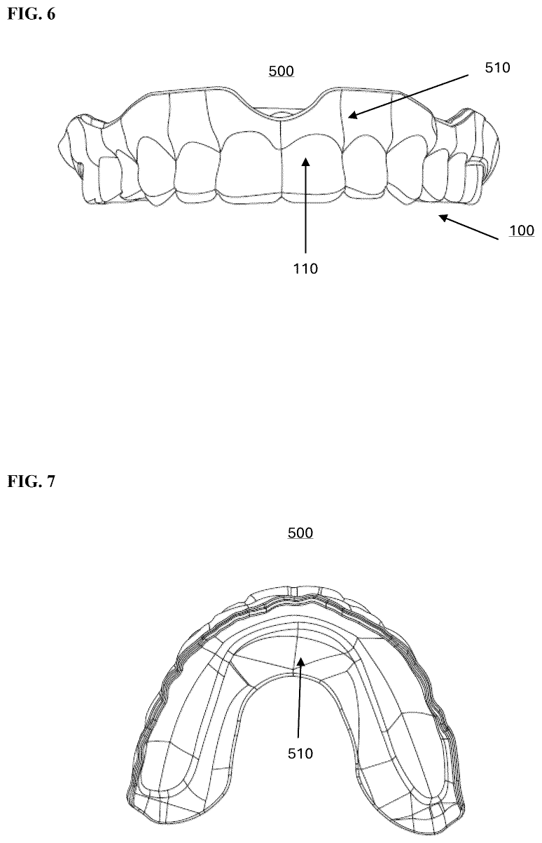

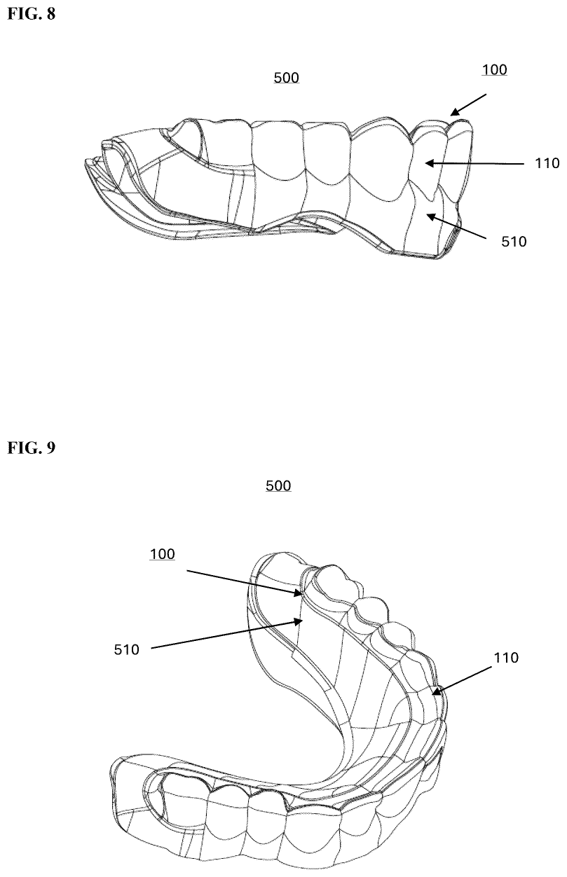

FIGS. 5-9 illustrate various views of an exemplary upper denture 500 according to the present description, comprising a first portion or layer 100 including at least one tooth-like structure 110. FIG. 5, which shows bottom view (from the perspective of the apical surface of the teeth) of the denture 500, includes a gum-like layer 510 overmolded onto the first portion or layer 100. As described herein, the gum-like layer 510 comprises a high-impact thermoplastic or heat moldable material, which can be the same or different as that of the first portion or layer 100. In certain embodiments, layer 510 forms an intermediate layer contacting the first portion or layer comprising the teeth, and either another thermoplastic material or the gums of a user. FIG. 6 illustrates a front view of the denture 500, and shows the first portion or layer 100 including teeth 110 with a gum-like layer 510 overmolded and affixed to layer 100. FIG. 7 shows the denture 500 and gum-like layer 510, wherein the first portion or layer 100 and teeth 110 are not visible. FIGS. 8 and 9 illustrate a side and top perspective view, respectively, of the denture 500, and shows the first portion or layer 100 including teeth 110 with a gum-like layer 510 overmolded and affixed to layer 100.

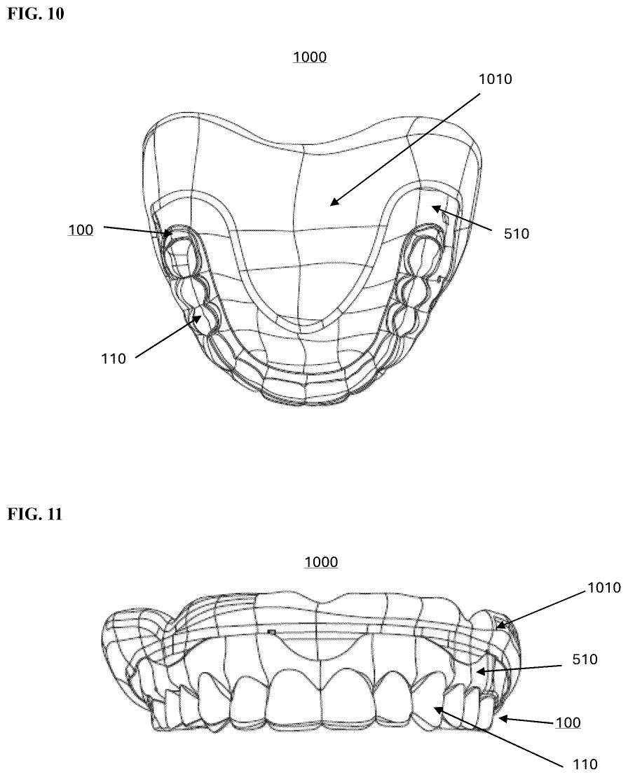

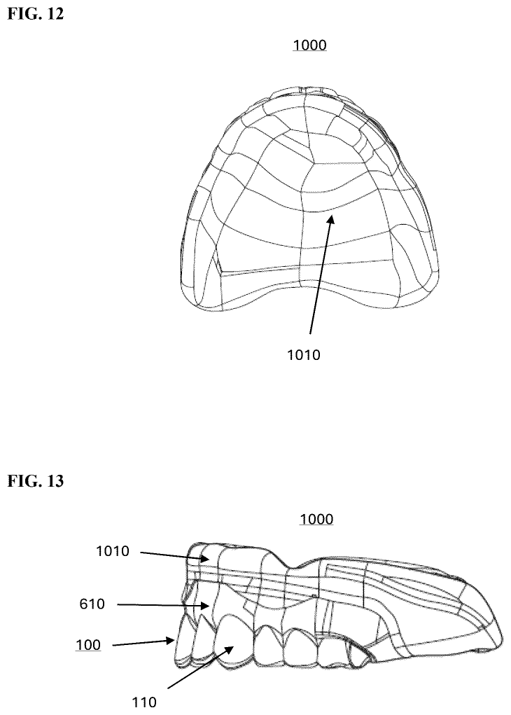

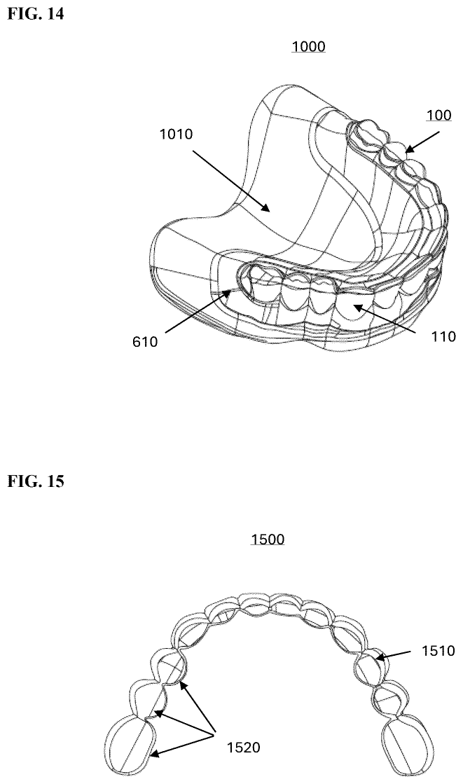

FIGS. 10-14 illustrate various views (bottom, front, top, side and bottom perspective, respectively) of an exemplary upper denture 1000 according to the present description, comprising a first portion or layer 100 including at least one tooth-like structure 110, wherein the first portion or layer comprises a high-impact thermoplastic or heat moldable material as described herein, an intermediate or layer 610 that comprises a high-impact thermoplastic or heat moldable material as described herein overmolded onto the first portion or layer, and a gingival portion or layer 1010 overmolded onto the intermediate layer, wherein the gingival portion comprises a high-impact thermoplastic or heat moldable material as described herein. In the illustrated embodiment of FIGS. 10-14, the denture 1000 includes a palate portion contiguous with the gingival portion or layer.

In certain embodiments, the denture includes an expandable/conformable heat moldable palate portion to facilitate a comfortable and stable denture fit. The expandable heat moldable palate portion is configured to accommodate varying mouth sizes and contour to patient tissue, such as the hard palate. To this end, the heat moldable palate portion may include channels, cuts, recesses, slits, folds, or other design elements that allow the heat moldable palate portion to expand and adjust the surface area and anatomy of the user to better fit the user's mouth, and/or to create a better suction to keep the denture in a substantially fixed position. The design elements and layers may allow the layer(s) to stretch side-to-side, as well as up and down. The described denture system thus provides a boil-and-bite method that allows the thermoplastic material to stretch to conform to different mouth shapes.

FIGS. 15-18 illustrate views of a first portion or layer 1500 and a lower denture (mandible) comprising a high-impact thermoplastic or heat moldable material as described herein, and includes at least one tooth-like structure 1510. In certain embodiments, the denture comprises a first portion or layer 1500 comprising a plurality of teeth 1510. As described herein, the first portion or layer, including the teeth, is entirely heat moldable and is formed of a high-impact thermoplastic or heat moldable material. FIG. 15 is a top view of the first portion or layer 1500. The teeth 1510 have an apical surface (chewing surface) and a basal surface, which is proximate to or affixed to an overmolded gum-like layer (gingival layer or intermediate layer as described herein) also comprising high-impact thermoplastic or heat moldable material. In certain embodiments, the basal portion of at least one of the tooth-like structures is configured to include a bracket structure 1520 to promote or facilitate a strong and stable interaction of the first portion or layer (i.e., the tooth layer) with the adjoining layer (gingival and/or intermediate). In certain embodiments, the bracket structure 1520 extends inwardly from the plane (or axis) of the tooth. In a preferred embodiment, the bracket structure 1520 is thin, e.g., 2 mm or less, so as to minimize deformation of the gum-like layers and to promote a comfortable denture fit.

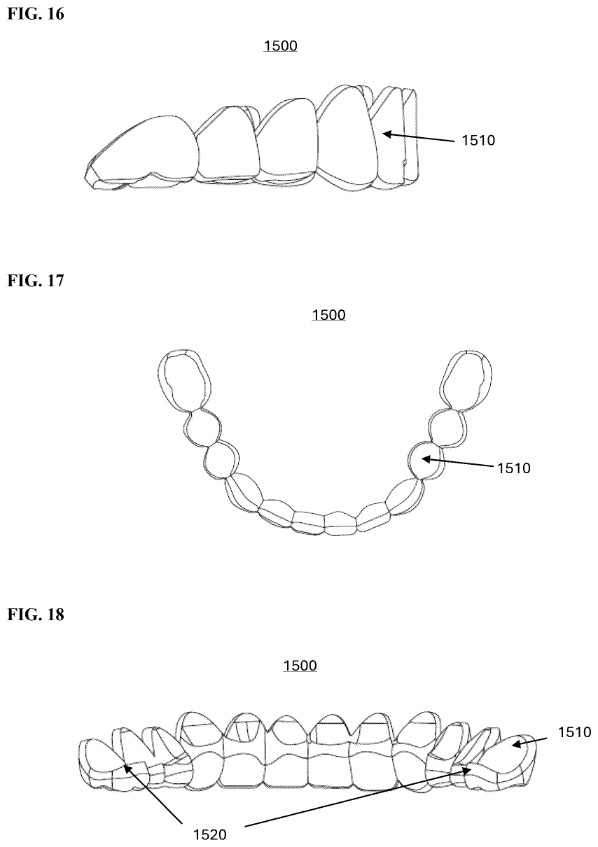

FIG. 16 provides a side view of the first portion or layer 1500 comprising at least one tooth-like structure 1510. FIGS. 17 and 18 provide bottom and posterior views, respectively, of the first portion or layer 1500 comprising at least one tooth-like structure 1510 and showing bracket structures 1520.

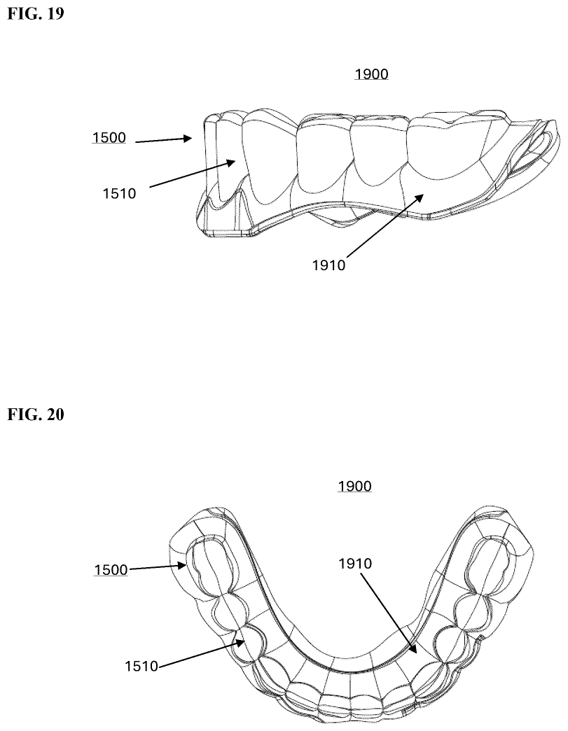

FIGS. 19-22 illustrate various views of an exemplary lower denture 1900 according to the present description, comprising a first portion or layer 1500 including at least one tooth-like structure 1510. FIG. 19, which shows a side view of the denture 1900, includes a gum-like layer 1910 overmolded onto the first portion or layer 1500. As described herein, the gum-like layer 1910 comprises a high-impact thermoplastic or heat moldable material, which can be the same or different as that of the first portion or layer 1500. In certain embodiments, layer 1910 forms an intermediate layer contacting the first portion or layer comprising the teeth, and either another thermoplastic material or the gums of a user.

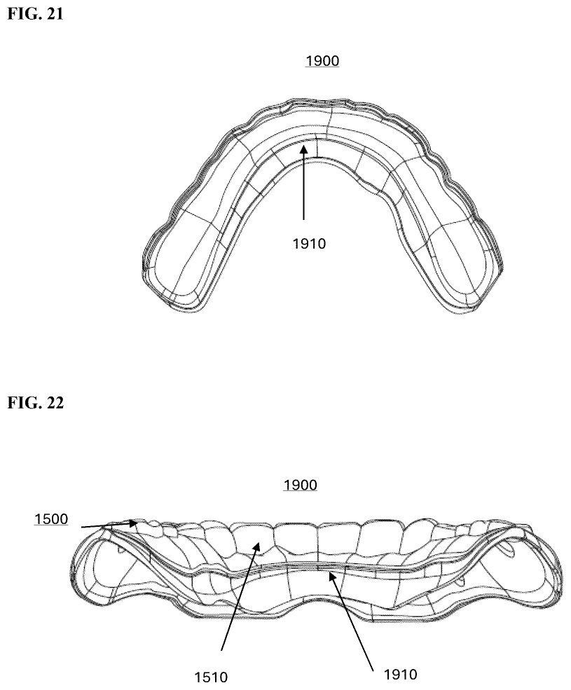

FIGS. 20 and 21 illustrate a top and bottom view, respectively, of the denture 1900, and shows the first portion or layer 1500 including teeth 1510 with a gum-like layer 1910 overmolded and affixed to layer 1500. FIG. 22 provides a posterior view of the denture 1900 illustrating the first portion or layer 1500 including teeth 1510 with a gum-like layer 1910 overmolded and affixed to layer 1500.

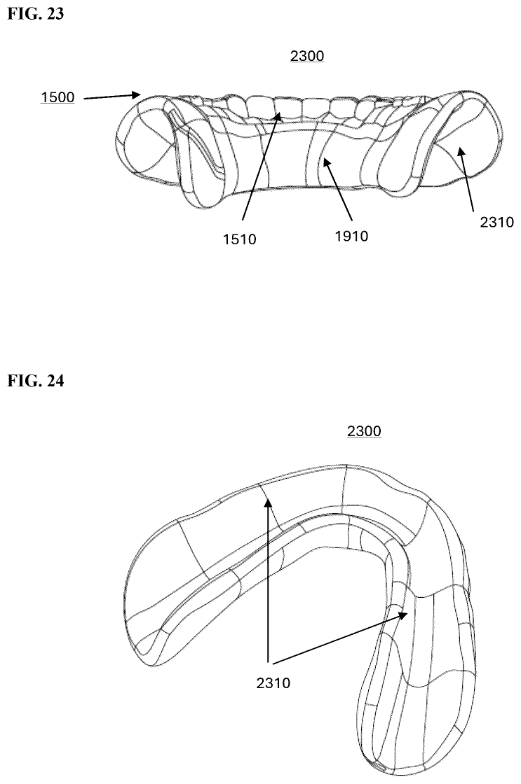

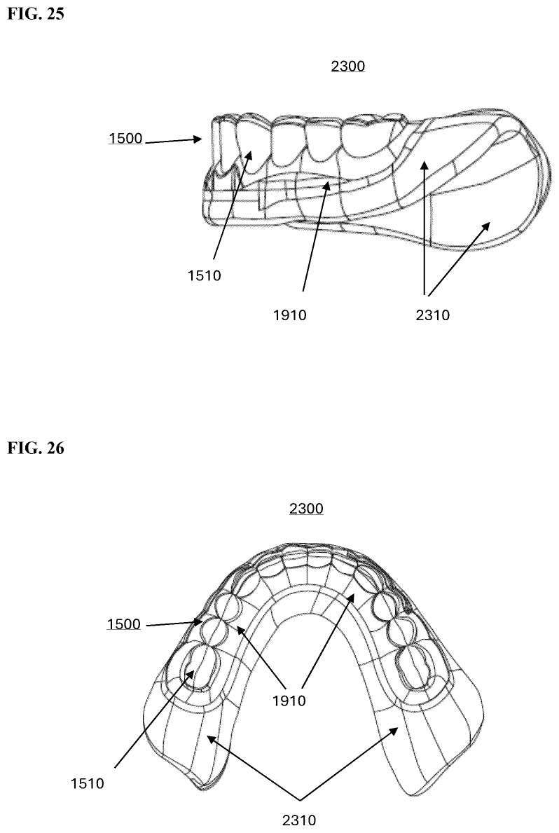

FIGS. 23-26 illustrate various views (posterior, bottom perspective, side and top, respectively) of an exemplary lower denture 2300 according to the present description, comprising a first portion or layer 1500 including at least one tooth-like structure 1510, wherein the first portion or layer comprises a high-impact thermoplastic or heat moldable material as described herein, an intermediate or layer 1910 that comprises a high-impact thermoplastic or heat moldable material as described herein overmolded onto the first portion or layer 1500, and a gingival portion or layer 2310 overmolded onto the intermediate layer, wherein the gingival portion 2310 comprises a high-impact thermoplastic or heat moldable material as described herein.

As discussed throughout, the first portion or layer 1500 comprising a high-impact thermoplastic or heat moldable material, e.g., an acrylic polymer, is proximate to or connected to an intermediate layer 1910 comprising a thermoplastic or heat moldable material, which is overmolded with a gingival layer 2310 comprising a thermoplastic or heat moldable material, e.g., polycaprolactone. Thus, the entire denture (first portion or layer, intermediate layer, and gingival portion or layer) is heat moldable or formable. In certain embodiments, the upper and lower denture are formed of the same heat moldable materials. In certain embodiments, the upper and lower are formed of different heat moldable materials.

As contemplated the first portion or layer and gingival portion or layer are both heat moldable but the first portion or layer is formed from a thermoplastic material with greater stiffness or elastic modulus so that the tooth layer is harder than the gingival layer when heated but all layers have a similar hardness when cooled.

In a preferred embodiment, the thermoplastic or heat moldable material of the gingival portion or layer becomes soft and stretchable, or “bubble gum-like” when heated and conforms to voids in the ridgeline or other tissue of a user. The gingival portion or layer may even be cut away with scissors or torn off. Where desired, the cut or torn away portion may then be added back on. The gingival and palate layers of the upper and lower dentures are not only maleable (e.g., deformable under compressive forces), but is also ductile (e.g., deformable under tensile forces). In some examples, the ductility of the layer ranges from around 80% to 1000%. Once cooled, the layer maintains its shape. This soft layer is extremely comfortable for the patient when in use and allows the denture to capture all of the patients undercuts. This feature allows for great retention that exceeds most custom dentures in the Kapur retention ratings.

In certain embodiments, the multi-layer, heat moldable denture as described herein includes an additional, intermediate layer positioned between the first portion or layer and the gingival portion or layer. In certain embodiments, the intermediate layer comprises the same thermoplastic material as either or both of the first layer and/or gingival layer or comprises a different thermoplastic material. Thus, in certain embodiments, the elastic modulus of the various thermoplastic materials comprising each layer of the denture can be “tuned” layer by layer to provide greater comfort and resilience while still providing a fully heat-moldable denture capable of being fit by the user.

In an example, after heating, the user may have a working time to fit the heat moldable denture of around 1-10 minutes. The denture can typically be fully hardened after about five minutes at room temperature (20-25° C.). The cooled and hardened denture is then functional and maintains its shape allowing users to eat without requiring the expensive process of creating standard dentures for patients at the dental office.

Exemplary high-impact thermoplastic or heat moldable materials suitable for incorporation into the multi-layer, heat moldable dentures described herein, include in certain embodiments in the first portion or layer and, if present, the intermediate portion or layer include from about 0.5 to about 10 ml, or from about 1 to about 5 ml of a citrate plasticizer, for example, tributyl 2-acetylcitrate; from about 1 to about 10 ml, or from about 2 to about 8 ml of an acrylic monomer, e.g., MMA monomer; from about 1 to about 10 g or from about 2 to about 8 g of an acryl polymer, e.g., PMMA. In certain embodiments, the gingival layer comprises polycaprolactone. In still additional embodiments, the tooth layer is a tooth color, e.g., white to off-white; and the intermediate layer and gingival layers are gum-colored, e.g., pink.

In an exemplary method, the high-impact thermoplastic or heat moldable material composition is prepared by the steps comprising admixing a liquid acrylic resin, a powder polymeric acrylic resin, and a plasticizer to form a flowable resin. Then the flowable resin is poured into sheets to cure and harden at ambient temperature or with heating. Once set (e.g., after about 20 minutes), the sheets are broken up and ground into pellets. The pellets can then be fed into the hopper or heating portion of an injection molding machine, and each respective layer is injected into a molding die as described herein, as it is shaded to the desired color.

### Exemplary Embodiments

In an aspect, the disclosure provides a multi-layer, heat moldable denture comprising: a first portion comprising a high-impact thermoplastic or heat moldable material, wherein the first portion includes at least one heat moldable tooth; and a gingival portion comprising a high-impact thermoplastic or heat moldable material positioned proximate to or affixed to the first portion, wherein the gingival portion is fitted to contours of gingival tissue of a subject. In any aspect or embodiment described herein, the first portion comprises a plurality of heat moldable teeth. In any aspect or embodiment described herein, the plurality of heat moldable teeth are individually or collectively adjustable. In any aspect or embodiment described herein, the first portion comprises a first heat moldable high-impact thermoplastic or heat moldable material. In any aspect or embodiment described herein, the gingival portion comprises a second high-impact thermoplastic or heat moldable material. In any aspect or embodiment described herein, the first high-impact thermoplastic or heat moldable material has a higher elastic modulus at about 60° C. than the gingival high-impact thermoplastic or heat moldable material. In any aspect or embodiment described herein, the first high-impact thermoplastic or heat moldable material, and the gingival high-impact thermoplastic or heat moldable material have approximately the same elastic modulus at about 37° C. In any aspect or embodiment described herein, the denture is an upper denture and includes a heat moldable palate portion that, when heated, is expandable and malleable to be fitted to contours of the palate surface of a subject. In any aspect or embodiment described herein, the heat moldable palate portion is configured with structures to provide at least one of improved positioning, fixation, stability or combination thereof to improve the occlusion of the teeth. In any aspect or embodiment described herein, the heat moldable palate portion comprises at least one of a post, cut (including a pit or recess), channel, dimple or combination thereof that allows the heat moldable palate portion to expand, stretch, flow and/or adhere to a subject's palate anatomy to improve the occlusion of the teeth. In any aspect or embodiment described herein, the denture is a lower denture. In any aspect or embodiment described herein, the denture further comprises a separate, heat moldable palate insert to improve denture positioning and/or comfort. In any aspect or embodiment described herein, the high-impact thermoplastic or heat moldable material comprises at least one high impact acrylic heat moldable material. In any aspect or embodiment described herein, the at least one high impact acrylic heat moldable material comprises polymethyl methacrylate (PMMA) and methyl methacrylate (MMA) monomer and optionally, a plasticizer, an emulsifier or a combination thereof. In any aspect or embodiment described herein, the gingival portion or layer comprises at least one of (poly)ethylene (e.g., polyethylene vinyl acetate), polycarbonate, polycaprolactone, or a combination thereof.

In an embodiment, the disclosure provides a multi-layer, heat moldable denture comprising: a first portion or layer comprising a heat moldable acrylic resin material, wherein the first portion or layer includes at least one heat moldable tooth; an intermediate portion or layer comprising a heat moldable acrylic resin material that is overmolded and affixed to the first portion or layer; and a gingival portion or layer comprising polycaprolactone affixed to the intermediate portion or layer, wherein the denture comprises a heat moldable, expandable palate portion, and the gingival layer is fitted to contours of gingival tissue of a subject, and the palate portion is fitted to contours of palate tissue of the subject.

In another aspect, the disclosure provides a method of manufacturing a multi-layer, heat moldable denture comprising the steps of: molding a first layer comprising a high-impact thermoplastic or heat moldable material, wherein the first layer includes at least one heat moldable tooth; and overmolding a gingival layer onto the first layer, wherein the gingival layer comprises a heat moldable material positioned proximate to or affixed to the first layer, wherein the gingival layer is fitted to contours of gingival tissue of a subject. In any aspect or embodiment described herein, the multi-layer, heat moldable denture is injection molded or 3D printed. In any aspect or embodiment described herein, the method comprises the step of overmolding an intermediate layer comprising a high-impact thermoplastic or heat moldable material onto the first layer, and then overmolding the gingival layer onto the intermediate layer. In any aspect or embodiment described herein, the first layer comprises a plurality of heat moldable teeth. In any aspect or embodiment described herein, the plurality of heat moldable teeth are individually or collectively adjustable. In any aspect or embodiment described herein, the first layer comprises a first high-impact thermoplastic or heat moldable material. In any aspect or embodiment described herein, the intermediate layer is affixed to the first layer, and the gingival layer is affixed to the intermediate layer. In any aspect or embodiment described herein, the gingival layer comprises a second high-impact thermoplastic or heat moldable material. In any aspect or embodiment described herein, the first high-impact thermoplastic or heat moldable material has a higher elastic modulus at about 60° C. than the second high-impact thermoplastic or heat moldable material. In any aspect or embodiment described herein, the denture is an upper denture and includes a heat moldable palate portion that, when heated, is expandable and malleable to be fitted to contours of the palate surface of the subject. In any aspect or embodiment described herein, the heat moldable palate portion is configured with structures to provide at least one of improved positioning, fixation, stability or combination thereof to improve the occlusion of the teeth. In any aspect or embodiment described herein, the heat moldable palate portion comprises at least one of a post, cut, channel, dimple or combination thereof that allows the heat moldable palate portion to expand, stretch, and/or adhere to a subject's palate anatomy to improve the occlusion of the teeth. In any aspect or embodiment described herein, the denture is a lower denture. In any aspect or embodiment described herein, the high-impact thermoplastic or heat moldable material is a heat moldable acrylic, and the second high-impact thermoplastic or heat moldable material is polycaprolactone.

In another aspect, the disclosure provides a kit comprising a container and the denture as described herein disposed therein.

Those skilled in the art will recognize or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims.

What is claimed is:

1. A premade, multi-layer, reversibly heat deformable denture comprising:
a first layer comprising a first high-impact reversibly heat deformable thermoplastic material that forms at least one heat adjustable thermoplastic tooth;
an intermediate layer comprising the first high-impact reversibly heat deformable thermoplastic material affixed to the first layer; and
a gingival layer affixed to the intermediate layer, the gingival layer comprising a polycaprolactone high-impact thermoplastic material that is reversibly heat malleable such that the gingival layer is adapted to be fitted to around all surface contours of gingival tissue of a subject.

2. The premade, multi-layer, reversibly heat deformable denture of claim 1, wherein the first layer is proximate to or permanently affixed to the gingival layer.

3. The premade, multi-layer, reversibly heat deformable denture of claim 1, wherein the at least one heat adjustable thermoplastic tooth comprises a plurality of heat adjustable teeth.

4. The premade, multi-layer, reversibly heat deformable denture of claim 3, wherein the plurality of heat adjustable teeth are individually or collectively adjustable.

5. The premade, multi-layer, reversibly heat deformable denture of claim 1, wherein the first high-impact reversibly heat deformable thermoplastic material comprises at least one high-impact acrylic heat deformable material.

6. (canceled)

7. The premade, multi-layer, reversibly heat deformable denture of claim 5, wherein the first high-impact reversibly heat deformable thermoplastic material has a higher elastic modulus at about 60° C. than the gingival layer.

8. The premade, multi-layer, reversibly heat deformable denture of claim 7, wherein the first high-impact reversibly heat deformable thermoplastic material, and the gingival layer have approximately the same elastic modulus at about 37° C.

9. The premade, multi-layer, reversibly heat deformable denture of claim 1, wherein the denture is an upper denture and includes a heat deformable palate portion that, when heated, is expandable and malleable so that it is adapted to be fitted to contours of a palate surface of the subject.

10. The premade, multi-layer, reversibly heat deformable denture of claim 9, wherein the heat deformable palate portion is configured with structures to improve the occlusion of the teeth.

11. The premade, multi-layer, reversibly heat deformable denture of claim 10, wherein the structures comprises at least one of a post, cut, channel, dimple or combination thereof that allows the palate portion to expand, stretch, and/or adhere to the subject's palate anatomy to improve occlusion of the teeth.

12. The premade, multi-layer, reversibly heat deformable denture of claim 1, wherein the denture is a lower denture.

13. The premade, multi-layer, reversibly heat deformable denture of claim 1, wherein the denture further comprises a separate, heat deformable palate insert to improve denture positioning and/or comfort.

14. (canceled)

15. The premade, multi-layer, reversibly heat deformable denture of claim 5, wherein the first high-impact acrylic heat deformable material comprises polymethyl methacrylate (PMMA) and methyl methacrylate (MMA) monomer and optionally, a plasticizer, an emulsifier or a combination thereof.

16. (canceled)

17. A method of manufacturing a premade, multi-layer, reversibly heat deformable denture comprising the steps of:
a. molding a first layer comprising a high-impact, reversibly heat deformable thermoplastic material, wherein the first layer includes at least one heat adjustable tooth; and
b. overmolding a gingival layer onto the first layer, wherein the gingival layer comprises a high-impact, heat malleable material positioned proximate to or affixed to the first layer, wherein the gingival layer is adapted to be fitted to contours of gingival tissue of a subject.

18. The method of claim 17, wherein the denture is injection molded or 3D printed.

19. The method of claim 17, wherein the method comprises the step of overmolding an intermediate layer comprising a high-impact, reversibly heat deformable thermoplastic material onto the first layer, and then overmolding the gingival layer onto the intermediate layer.

20. The method of claim 17, wherein the first layer comprises a plurality of heat adjustable teeth.

21. The method of claim 20, wherein the plurality of heat adjustable teeth are individually or collectively adjustable.

22. The method of claim 17, wherein the first layer comprises a first high-impact, reversibly heat deformable thermoplastic material.

23. The method of claim 19, wherein the intermediate layer is affixed to the first layer, and the gingival layer is affixed to the intermediate layer.

24. (canceled)

25. (canceled)

26. The method of claim 17, wherein the denture is an upper denture and includes a heat deformable palate portion that, when heated, is expandable and malleable such that it is adapted to be fitted to contours of the palate surface of the subject.

27. The method of claim 26, wherein the heat deformable palate portion is configured with structures to improve the occlusion of the teeth.

28. The method of claim 27, wherein the heat deformable palate portion comprises at least one of a post, cut, channel, dimple or combination thereof that allows the palate portion to expand, stretch, and/or adhere to the subject's palate anatomy to improve the occlusion of the teeth.

29. The method of claim 22, wherein the first high-impact, reversibly heat deformable thermoplastic material is a heat deformable acrylic, and the gingival layer comprises polycaprolactone.

30. A premade, multi-layer, reversibly heat deformable denture comprising:
a first layer comprising a heat deformable high-impact acrylic resin material, wherein the first layer includes at least one high-impact acrylic resin heat adjustable tooth;
an intermediate layer comprising the heat deformable high-impact acrylic resin material that is overmolded and affixed to the first layer;
a gingival layer comprising high-impact polycaprolactone affixed to the intermediate layer, wherein the gingival layer is adapted to be fitted around all surface contours of gingival tissue of a subject; and optionally
a heat moldable palate portion, wherein the palate portion is adapted to be fitted to contours of palate tissue of the subject.

31. (canceled)
